(19) United States
(12) Patent Application Publication
(10) Pub. No.: US 2002/0069204 A1
(43) Pub. Date: Jun. 6, 2002

(54) System and method for in-context editing

(76) Inventors: Roger Kahn, Brooklyn, NY (US); Sameer Bhargava, Port Washington, NY (US); Hareesh Kadlabalu, Port Washington, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 09/965,901

(22) Filed: Sep. 28, 2001

Related U.S. Application Data
(60) Provisional application No. 60/236,081, filed on Sep. 28, 2000.

(51) Int. Cl. G06F 17/30; G06F 7/00

(52) U.S. Cl. 707/10

(57) ABSTRACT

The present invention presents a system and method editing content elements within the context of the Web page that contains the content elements. Web pages are requested from a computer serving Web pages by a client using a Web browser, the content comprising the requested page or pages being stored and managed by a database or other data store. Embedded in the requested page is a dynamic database reader (DDR), which transmits a request to a Control Program (CP) running in the server. Upon this transmission the CP queries the database for page content and returns the content to the DDR. As the requested data is received, the DDR places editorial controls in the vicinity of one or more editable content elements and passes the resultant data off to the browser to be rendered and displayed to the user. When a user wishes to modify a content element, he or she selects the editorial control associated with the element, which causes the control program to download and execute an in-context editor within an auxiliary browser window. The in-context editor displays the selected content element, controls for modifying the currently selected content element or choosing a new content element, and transactional controls to either save or cancel editorial changes. When the changes are saved, the in-context editor issues a message to the control program to update the content element in the database and refresh the Web page to display the changes. The in-context editor window closes and the user is free to edit another content element or navigate to a new Web page.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to editing content contained in digital documents and database driven content management systems. More particularly, the present invention relates to a system and method whereby a document author can make changes to document content contained in a database and presented on a Web page, while remaining within the context of the page being edited. The present system and method allows the author to view the page as remotely located content is edited and immediately see the effect of the changes on the page. As used herein, the term Web is intended to include any document or file stored on a server and accessible over a network by a variety of client devices.

Database driven content management systems are typically used to automate content management for large-scale, high-volume online operations. These systems facilitate the dynamic generation of pages with content that frequently changes, eliminating the need to manually rewrite pages every time there is a change in the underlying data. Examples of such operations include providing clients with up-to-date news, pricing information, real-time stock quotes, and the ability to customize the presentation of a page in terms of its layout and included content.

Web sites or similar information delivery systems that provide this functionality typically comprise hundreds or thousands of pages, some of them dynamic, e.g., the page presented to the user changes in response to changes in the underlying content or identity of the user, and others static. Updating or otherwise editing dynamic pages is a major operation made significantly more complex due to the fact that many systems do not provide for automation of this process. Furthermore, changes to static pages must be handled manually whereby each page is edited individually. This limitation can be illustrated by examining the differences between dynamic and static pages.

Dynamic pages display time-variant, user dependent information. Examples of dynamic Web pages are personalized mailboxes, customized order forms, or a Web page designed to present a user with his or her favorite news topics. Since the information and layout of these types of pages changes depending on the time they are accessed, or who they are accessed by, they must be generated dynamically, e.g., at run time when the user requests the page. The content displayed by the dynamic page is stored in a database or other data management system. The content is retrieved from the database and assembled into a dynamic page at run time by means of templates.

Templates are typically stored by servers. Templates, which are executed on a server when a page is requested, contain variables and instructions that may be written in a variety of programming or scripting languages. Exemplary scripting languages include Java Server Pages, JavaScript, VBScript, JScript, Active Server Pages, and Perl. Optionally, using parameters retrieved from a user profile stored on the computer serving the dynamic page, or another computer accessible from the serving computer, a run time engine carries out instructions contained within the template to retrieve the appropriate content from the database and to encode the content in a language such as HTML (Hypertext Markup Language) or XML (eXtensible Markup Language). The resultant encoded content is served to requesting clients as a data stream that defines the dynamic page for display in a browser or similar viewer application.

In principle, updating a dynamic page is a fast and straightforward process due to the fact that all content is stored in a database, thereby facilitating global editing. For example, suppose that in a set of Web pages, each page contains an identical text story, such as a corporate slogan. Rather than having to manually change the text story on each page, it is necessary to change only the text story stored in the database. At run time, the new text automatically appears on each page as the page is generated, replacing the older and unwanted text.

What makes the editorial process inefficient, however, is the problem of “blind editing”. In order to edit or modify the data contained within a database, a database administrator or developer uses database management tools like those provided by major database vendors such as ORACLE™ and SYBASE™. These tools, which provide either a command line or graphical interface to the data, are suitable for viewing the content elements individually (e.g., selecting a paragraph of text or a bitmapped image) or for selecting subsets of the total content. Indeed, an editor using these tools can select a specific image, replace it with an updated image, and view the new image using a separate application.

These tools are not, however, suitable for determining how the new image appears as part of the dynamically generated page or pages with which it is associated. For example, each time an editor modifies the data by using a database management tool, he or she is able to view neither the context nor the format in which the new data is displayed on the dynamic page. Because of this limitation, the best an editor can do is to continually switch between the database management tool and the browser or other viewing application used to display the dynamic page. Thus, the editing of a dynamic page is a semi-automated process that needs to be fully automated, thereby eliminating the need to utilize multiple applications to view and modify content. The attempt to automate, however, raises another problem: how to handle multimedia content that requires unique editorial programs, such as image content that requires an independent image manipulation program to effect changes to an image.

Static pages are physical files that are retrieved or downloaded from a server device, whereby both the client and server are connected to a common network or disparate networks interconnected with one another. These pages are created through the use of visual tools such as MICROSOFT FRONTPAGE™, or coded manually through the use of a text editor, preferably one geared to properly distinguishing and formatting HTML or other markup syntax. Static pages can also be generated by redirecting the output of dynamic pages to static files. When requested by a client, a server delivers the file requested “as is” to the requesting browser. In other words, a run time engine is not invoked and rerun each time a request for the page is received; the page is simply delivered upon request to the client.

Static pages are widely used to deliver fixed content that necessarily does not change over time, for example, a corporate press release or a research publication. For this reason, permanent hard-coded files are created by the content's author and stored on a persistent storage device such as a fixed hard disk or managed by a database. When a static page is served, the page is rendered identically each and every time, with the same content and format, on all equivalent browsers. Indeed, the format and content do not vary as a function of time. When a user navigates away from a static page, the page still physically exists on the user's hard drive as one or more files, located in a “cached Web pages” or similarly named directory.

Because static pages are served rather than generated, thereby requiring no computation, they are delivered quickly and efficiently to the requesting client. They are, however, particularly time consuming and costly to edit. First, modifying static pages requires a search for hard-coded information that is potentially scattered and repeated across hundreds of files on multiple independent storage devices. Secondly, changes to a single piece of information repeated over many pages can require republishing of an entire Web site that relies on the page, or significant portions of it, which is a computationally expensive process.

Editing static pages presents further problems for e-commerce businesses. Inconsistencies frequently arise when a single piece of information is sequentially modified in many places, especially when some of those places are overlooked or re-populated with incorrect data. Furthermore, modifying content can lead to undesired alterations in the look and feel of a Web page or even portions of a Web site. Such inconsistencies are difficult to isolate unless each page is individually examined. As a result, each page must be republished after every change to its content, corrected if necessary, and republished once more. This repeated publication process consumes significant human and computational resources.

There is thus a need for a system that eliminates the problem of blind-editing dynamic pages and the modify-publish-view problem associated with editing static pages.

### BRIEF SUMMARY OF THE INVENTION

It is an object of the present invention to provide a system and method that allows a user to edit dynamic Web pages within the context of the Web page as it is presented to a user.

It is another object of the present invention to provide a solution to the problems associated with “blind editing”.

It is another object of the present invention to provide a solution to the modify-publish-view process of editing.

It is another object of the present invention to provide a unified interface to viewing a page of content and editorial controls to modify the content.

It is another object of the present invention to provide a solution to the problem of requiring external editorial applications to modify specialized types of multimedia content.

The above and other objects are achieved by a system and method that allows a user to modify content elements embedded within a page in the context of the page as it appears within an application displaying the content. Users interact with a content viewing application, such as a web browser, to navigate sites on the World Wide Web (WWW) or an intranet. When a user accesses a site enabled by the present invention, data embedded within the content page is extracted from a data source. Data sources include databases, file systems on fixed disk drives, optical disks, or other types of data storage and management structures. The extracted data is passed to the requesting client.

Upon receipt of the requested data, each content element is analyzed to determine whether it is editable and if so, tagged with an editorial control. When the client discovers an editable element, it is associated with an editorial control. The non-editable content, editable content, and associated editorial controls are rendered by a browser and displayed on a display device. A user identifies a content element for modification and selects its associated editorial control. The system serving the content determines the data and browser types selected by the user and instantiates a dialog to display the selected element and one or more controls for modifying the selected element.

The content element is modified as is appropriate and the transaction is confirmed. The confirmation message is transmitted to the server where it is recorded and the specific data values modified at the data source. The page containing the modified content element is then re-transmitted to the client, allowing the user to immediately view the changed content element and its effect on other content elements displayed on the page. Alternatively, the process is executed on a stand-alone workstation whereby all necessary software and hardware components are stored and executed from a single device.

The above and other objects of the present invention are also achieved by a system and method of editing content on either a static or dynamic Web page in the context of the page as it is being displayed by a Web browser or other viewer application. This is achieved by architecturally separating system components into three tiers: Model, View and Control. The Model tier is where the content managed and served by the system is stored. A database or other data storage system is used to create a data “model” of the structure and formatting of the content that the user views through interaction with the other tiers. The system models managed content by using any type of data management paradigms including, but not limited to, relational databases, object oriented databases, hybrid relational-object oriented databases, flat file databases, and other paradigms that are well known to those skilled in the art.

The Model tier also contains static pages. Static pages are files that contain information formatted in a mark-up language, such as HTML. Static pages may contain programs embedded within the marked-up information. The programs contained in static pages run in the View tier when the static page is displayed and are typically developed with technologies such as JavaScript, ActiveX, and Java applets.

The Control tier contains templates that generate dynamic pages. In addition to the templates, the Control tier contains a software component referred to as the Control Program (CP). The CP provides an API that allows client applications executing in the view tier to operate on the content in the database, committing content changes to the database and both serving and generating static and dynamic Web pages, respectively. The CP also assists in the editorial process by reading page content directly from the database and providing formatted data to software components in the View tier.

The View tier is composed of three software components that work together and with components in the other tiers to present user interface controls on the client computer for editing content elements within the context of the page in which they appear. The first component is the Web browser, which is used to navigate among Hypertext documents and other types of interactive content located on computer systems. The browser contains functionality to retrieve and render the text, images, and other multimedia content contained in these pages.

The second component is the Dynamic Database Reader (DDR). The DDR is a program that is embedded inside the static or dynamic page. Typical technologies used to implement a DDR are JavaScript, ActiveX and Java applets. The DDR executes inside the Web browser when the static or dynamic page is rendered. The DDR retrieves page content from the database by way of an API provided by the CP and places HTML code within the static or dynamic page that is rendered by the browser alongside the other content that is embedded directly inside the page. The DDR places an “edit” button beside each retrieved content element. The third software component executing in the View tier is the In-Context Editor (ICE) that is used to edit content elements directly in the browser while the user views the content elements. The ICE allows the user to view an editable field value as unformatted data. Graphical controls are supplied within the ICE that allows the user to update or otherwise modify a particular content element. After the changes have been made in the ICE, interface controls allow the user to cancel the transaction or commit the changes to the database and view the resultant page.

The components distributed across the several architectural tiers generally work together as follows. A user at a client workstation loads a browser application and navigates to a Web page by using techniques that are well known to those skilled in the art. A Web site enhanced by the present invention receives requests for static and dynamic pages. The Web site initially responds by transmitting the content of the static page (including the DDR) or executing the template and transmitting its resulting page (including the DDR). The browser receives the page and executes the DDR on the client's computer. The DDR queries the database for the desired page content by using APIs provided by the CP. The DDR receives page content and places an HTML “edit” control or button beside each editable content element. The modified data stream is delivered to the browser for rendering and presentation to the user.

After reviewing the page content, the user edits a specific content element by selecting the “edit” control placed beside each editable content element by the DDR. Selection of the “edit” control instructs the DDR to request an In-Context Editor that the user employs to modify the content element. The DDR passes the request to the CP to dynamically generate an ICE that is appropriate for the data selected and browser employed by the user. The CP determines the browser type and data type, e.g., audio, text, graphics, and loads the ICE directly in an auxiliary window within the browser. The ICE, which displays editorial and transactional controls, allows the user to modify the content element and either save or cancel the changes. If the editorial changes are saved, the ICE sends a message to the CP to update the content in the database with the newly modified content.

After receiving the update request, the CP updates the database with the newly modified content and returns a message to the ICE that the update has completed successfully. The ICE issues a message to the browser to refresh the page, which is equivalent to re-requesting the page as explained above, and to display how the modified content appears on the page. The page is refreshed and the ICE window closes. At this point, the user is free to begin the editorial process again on either the same or a new content element. If additional content does not need to be modified, the browser is closed and all client software components are released from memory, ending the in-context editing process.

The solutions provided by the present invention solve problems associated with current solutions through the use of an “in-context editor” that provides editorial controls and direct hooks to editorial programs associated with each data element displayed on a page. Elements on static pages are provided similar controls for authors to directly edit page content and immediately view the impact of the changes. The solution further allows authors to determine the page elements capable of being modified “in-context” and applies editorial controls to only the selected elements. The editing of dynamic and static pages, which are two different paradigms, is therefore combined into a single intuitive process.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A is a block diagram presenting a configuration of various hardware and software components used for in-context editing in a network environment according to one embodiment of the present invention;

FIG. 1B is a block diagram presenting the system architecture and components used for in-context editing of a Web page in a stand-alone environment according to an alternative embodiment of the present invention;

FIG. 2 is a flow diagram presenting an overview of the process of in-context editing, according to one embodiment of the present invention;

FIG. 3 is a flow diagram detailing the process of editing content in-context, according to one embodiment of the present invention;

FIG. 3A is a flow diagram continuing the process of editing content in-context, according to one embodiment of the present invention;

FIGS. 4A through 4D are a series of screen diagrams presenting editable image content and the use of an in-context editor to modify the content in the context of the application displaying the content, according to one embodiment of the present invention;

FIGS. 5A through 5D are a series of screen diagrams presenting editable date content and the use of an in-context editor to modify the content in the context of the application displaying the content, according to one embodiment of the present invention;

FIG. 6A is a an exemplary HTML file incorporating a DDR and used to generate output that is editable in context; and

FIG. 6B is a screen diagram presenting the rendered HTML code presented in FIG. 6A.

### DETAILED DESCRIPTION OF THE PREFERRED EMBODIMENTS

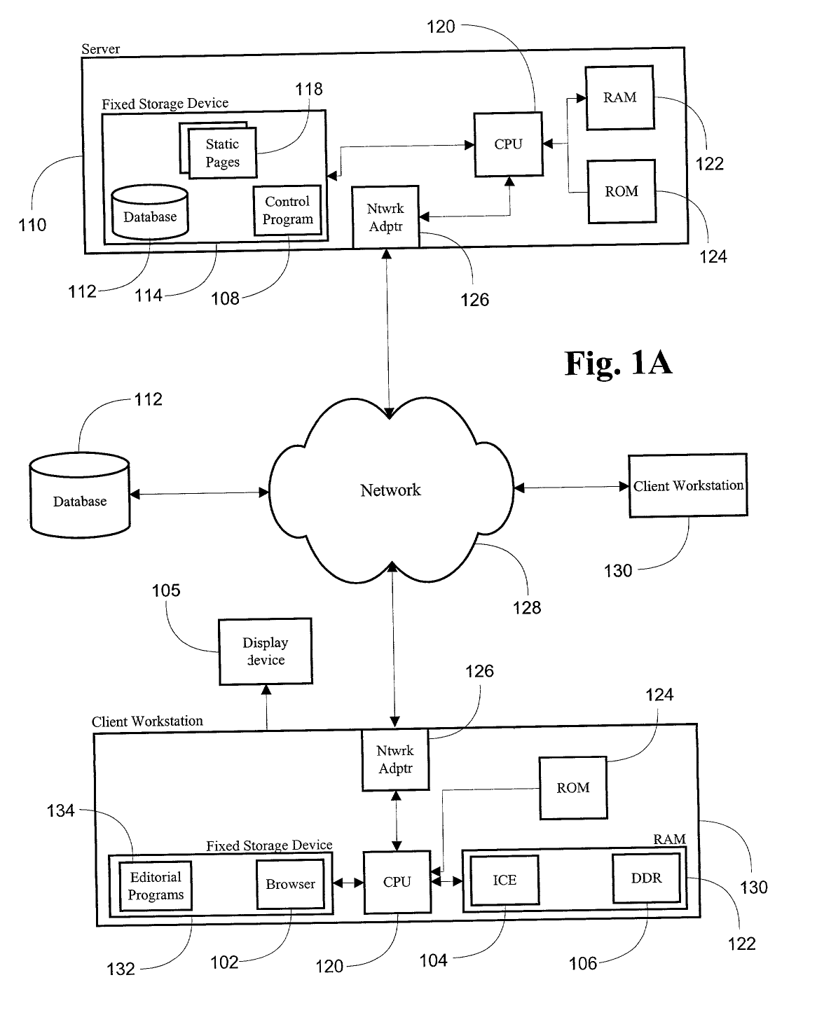

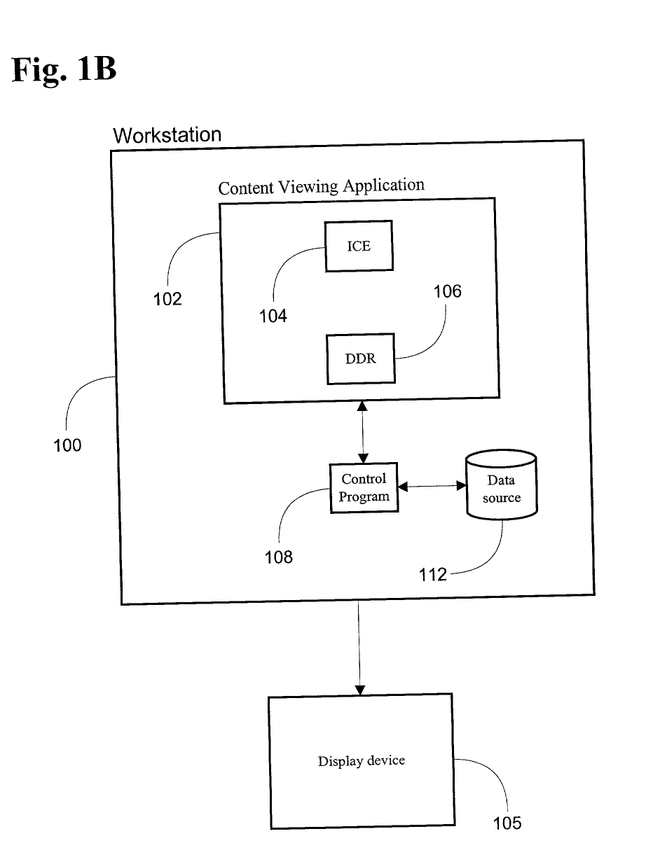

With reference to FIGS. 1A through 5D, detailed embodiments of the invention are now presented. FIG. 1A presents a client/server embodiment of the hardware and software components of the instant invention in a network environment. The components are configured according to a Model-View-Control (MVC) architecture, which is a derivative of the well-known client-server architecture. Managed content is held in a database 12 or other data structure that “models” how the content is organized, e.g., the “Model” tier. The View tier is typically remote from the database, residing on a client workstation 130. Its function is to present the content modeled by the database 112 to the user. Residing architecturally between the Model and View tiers is the Control tier, which controls interaction between a user and the managed content.

The Model and Control tiers are executed on a server computer 110. The server 110 comprises a general-purpose programmable digital microprocessor, also referred to as the Central Processor Unit (CPU) 120. The CPU 120 controls all the data processing functions of the computer. The CPU 120 is electrically coupled to Random Access Memory 122, which provides storage for transient data the CPU 120 needs quick access to. The CPU 120 is further coupled to Read-Only Memory 124 typically containing instructions used by the computer at startup.

Managed content is stored in a database 112 or other file structure, such as a filesystem. The database is preferably configured with a direct connection to a server computer 110, such as residing on a fixed storage device 114 integrally connected to the server. Alternatively, the system utilizes a database 112 or databases located remotely from the server 110. Communication between the server 110 and the remote database 112 is conducted across a network 128. The server computer further comprises a network adapter 126 that controls data traffic being received and transmitted by the server 110.

Multiple database types are contemplated by the invention. The database 112, for example, consists of a relational database, an object oriented database, a hybrid relational-object oriented database, or a flat-file database. Where a relational database is used, managed content is stored and normalized among one ore more related tables. Tables are organized according to rows and columns. The columns are also referred to as fields. The intersection of a row and column in the table represents a field value, or equivalently a piece of content that represents a portion of the total site or page content. A field value may be text, an image, a sound file, or any other type of digital content that is defined by the field. Any piece of content can be identified by its table name, column name, and an index number.

The fixed storage device 114 is composed of one or more high capacity digital storage devices, such as hard disk drives, that provide persistent storage for application and data files. In addition to a database 112, the fixed storage device 114 stores the Control Program (CP) 108. The CP 108 is architecturally part of the Control tier and executed by the server 110. The CP 108 facilitates interaction between the Model and View tiers by receiving content requests from the DDR and returning a data stream formatted with content retrieved from the database 112. The CP 108 also provides a set of Application Programming Interfaces or APIs (not pictured) that provide access to managing content stored within the database, including selecting and updating content.

Client workstations 130 communicate with the server across a computer network 128. Like the server 110, client workstations 130 comprise a network adapter 126 for controlling network data traffic received or transmitted by the client, a CPU 120 for controlling data processing, and Read-Only Memory (ROM) 124 containing instructions used by the CPU 120 at startup. The client also comprises a fixed storage device 132 for persistent storage of application and data files. The fixed storage device stores an Internet browser (“browser”) 102, which contains program code to render and navigate Internet content according to a variety of markup languages. The browser also transmits data according to the FTP (File Transfer Protocol), HTTP (Hypertext Transfer Protocol), and other protocols. Through the use of an expandable architecture, modem Web browsers have the ability to hook into external programs that assist in the rendering of non-HTML or other types of unsupported data. Exemplary browsers are NETSCAPE NAVIGATOR™ and MICROSOFT INTERNET EXPLORER™. The browser 102 is one element of the View tier according to one embodiment of the present invention.

The client computer executes application programs in RAM 122 that are downloaded across the network 128 from the server 110. The first of these applications is the Dynamic Database Reader or DDR 106. The DDR 106 is transmitted as part of the formatted content returned by a dynamic page request or a static page request. The DDR is run in the Web browser, transparent to the user, when the Web browser renders a page. The DDR 106 is the module responsible for obtaining page content from the database by accessing the APIs of the CP 108. Page data returned from the CP 108 is passed to the DDR 106, which passes the data to the browser for rendering. The DDR also generates HTML “edit” buttons that are inserted into the HTML data stream and rendered adjacent to editable content to allow the in-context modification of the data.

A user begins the in-context editing process by selecting the HTML “edit” button displayed by the browser beside editable content. When the “edit” button is selected, the DDR 106 executes an In-Context Editor 104 corresponding to the type of data that the user is requesting to modify. For example, if the user selects an edit button associated with a graphic, the CP instantiates an ICE with functionality to display image data.

As previously mentioned, the second program downloaded from the server and executed on the client is the In-Context Editor or ICE 104. The ICE 104 is displayed to the user simultaneously with the page that contains the content that is being edited. This allows the user to view the content as he or she manages it in the database. The data in the Web page changes in response to saved edits made to data within the ICE window. Edits are committed to the database by the user's selection of a “save” control provided by the ICE's GUI. The ICE enables the human editor to edit the content elements by presenting the human editor with an editing interface that is specific to the data type of the content element. Depending on the data type of the content element, the interface may be a word processor, a data entry box, a graphical drawing program, or any other content editing interface available to the editor's computer system. The DDR initially loads the editing interface with a copy of the content element from the database. Upon completion of the edits the editor selects the “save” control. When the “save” control is selected, the DDR transfers the edited content to the CP, which writes the updated content element to the database.

Thus, the ICE allows the human editor to access the database, modify its contents one element at a time, and initiate updates to the database. Updating the database results in updating of the Web page that was edited.

FIG. 1B presents an alternative embodiment of the present invention whereby all software components necessary to practice the invention are encompassed within an individual workstation 100. A workstation computer 100 may be a personal computer such as a COMPAQ DESKPRO™ or HP PAVILLION™. Alternatively, workstation computer 100 may be a computer configured as a server in a network environment, such as an IBM NETFINITY™ or SUN SPARCstation™. According to this embodiment, the content viewing application 102, ICE 104, DDR 106, CP 108, and data source 112 reside on a common workstation 100.

The content viewing application 102, typically a browser capable of rendering data coded according to multiple types of markup and scripting languages, is used to request a page of content. The requested page could be a static page served from a file or a dynamic page generated by a template. The content viewing application renders the page and in the process of rendering executes the DDR. The DDR requests data from the CP 108, which retrieves the requested data from an integrated data source 112 such as a database or file system on a fixed hard disk. The retrieved data is passed to the DDR 106 where it is formatted for display by the browser 102 on the workstation's display device 105. As with other embodiments, the DDR 106 places “edit” controls beside each editable content element when the content element is displayed.

When the user decides to edit an editable content element, the DDR 108 instantiates a data and browser specific ICE 104 for modifying the content. The ICE 104 contains controls that allow the user to select new data or otherwise modify the selected content element. Changes are made to the content and either rolled back or committed to the data source 112. When committed, the new data values are transmitted from the ICE 104 to the CP 108 and recorded on the data source 112. All of the data processing, manipulation and display are conducted on the workstation 100 without the need for remote or networked resources not integrated or directly coupled to the workstation 100.

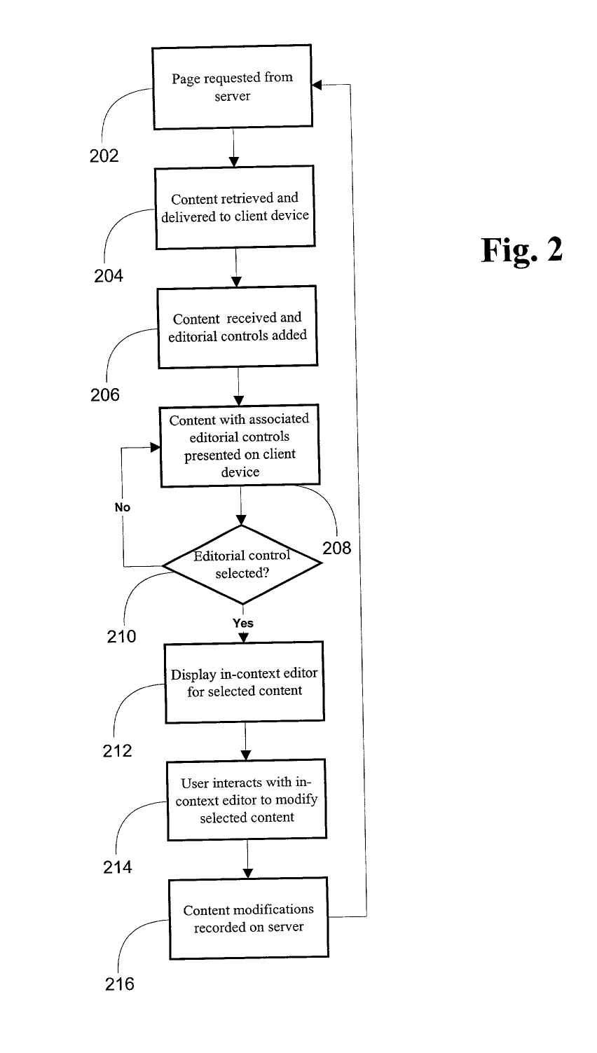

FIG. 2 is a flow diagram presenting a high level overview of the use of the hardware and software components presented in FIGS. 1A and 1B to edit content in the context of the application presenting the content. A user requests content pages from a server through the use of a content viewing application such as a browser, step 202. The content is retrieved and delivered to the requesting client device, step 204. Upon receipt of the content, editable content elements are identified and associated with editorial controls that allow the user to modify the value of the content element, step 206. The non-editable content, editable content and associated editorial controls are presented to the user on the client's display device, step 208.

The formatted content is presented to the user on the client display for review and/or modification. When the user identifies a content element that he or she wishes to modify, he or she selects the associated editorial control, step 210. Selecting an editorial control causes the instantiation of a data and browser appropriate ICE, which is displayed alongside the content viewing application on the display device, step 212. Using controls provided through the ICE's graphical interface, the user modifies the selected content element, e.g., replacing a selected image with new image data, step 214. Modifications are made to the selected content element and recorded on the server providing the content, step 216. The content page is re-requested from the server and displayed on the client with the modified content allowing the user to immediately see the effect of the changes to the content element and other elements on the page, steps 202 through 208.

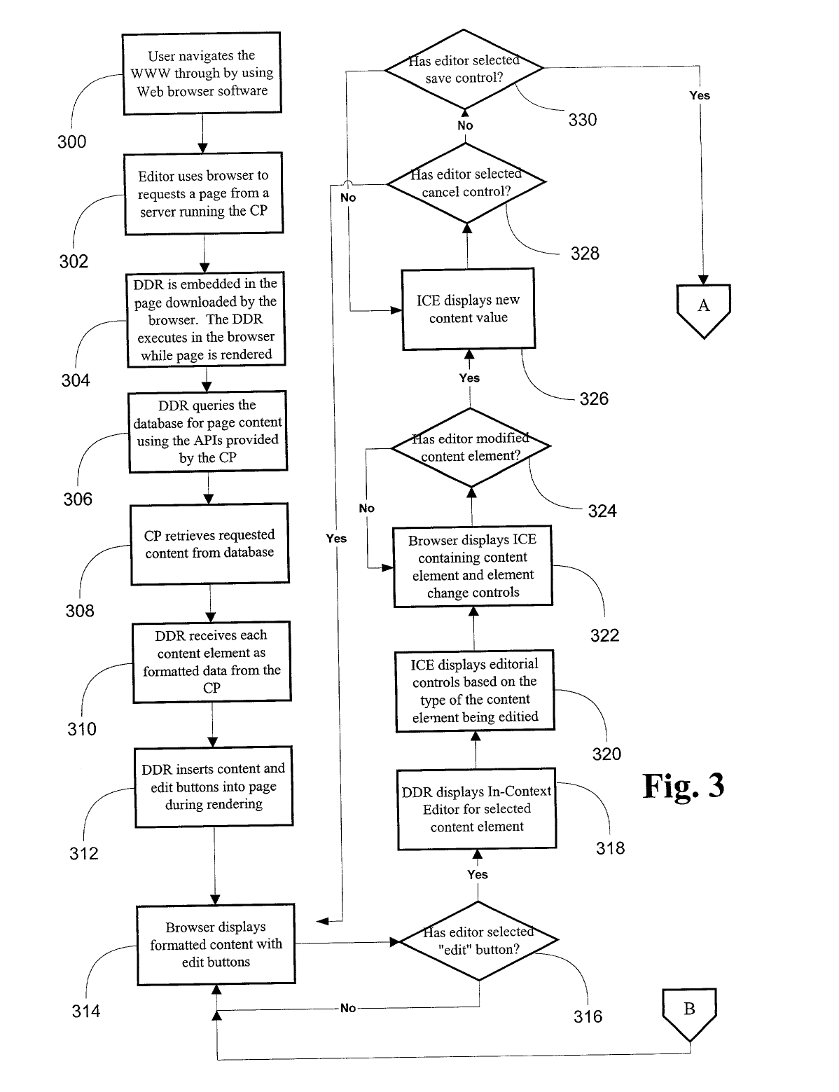

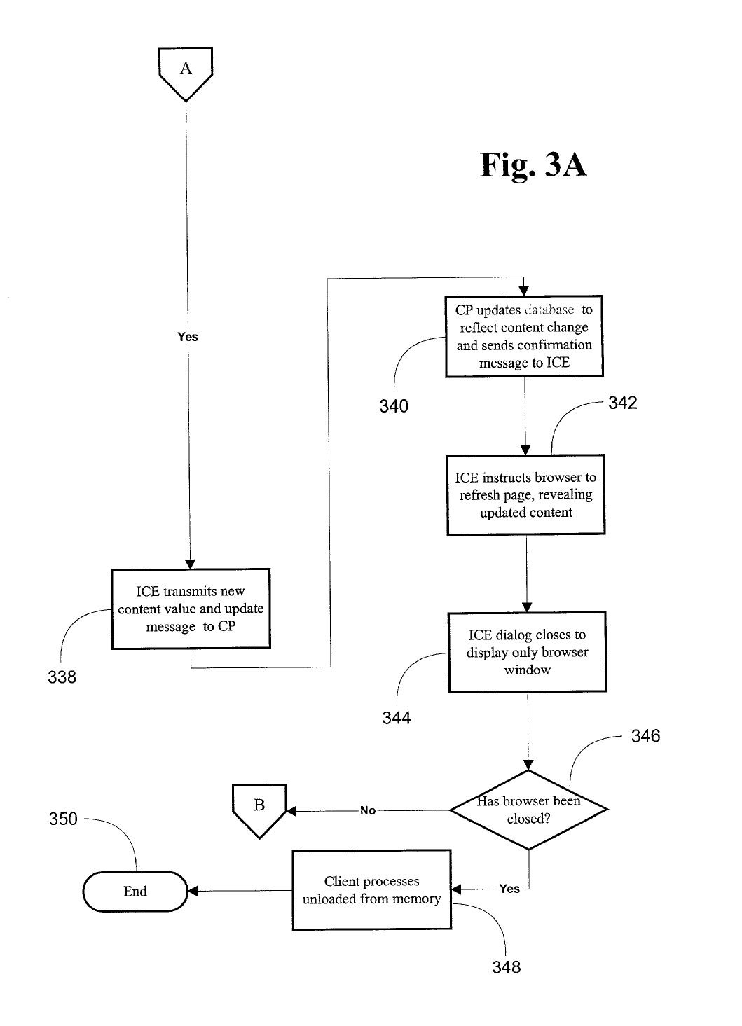

Turning to FIG. 3, a flow diagram detailing an embodiment of the process of in-context editing using the system presented in FIGS. 1A and 1B is presented. A Human editor navigates the World Wide Web (“WWW” or “the Web”) from a client workstation by interacting with an Internet web browser, step 300. Each page available on the Web is identified and locatable through the use of a unique Uniform Resource Locator (“URL”). A user enters a URL in an address bar provided by the browser's user interface. The browser initiates communication with the server identified by the URL and retrieves the requested page. Alternatively, where the user is already viewing a page downloaded by the browser, links contained within the document can be selected to navigate to subsequent pages. The links within the document are a graphical representation of a URL that instruct the browser to retrieve and load the indicated page when selected.

In order to utilize the present invention, the human editor uses the browser to request a page from a server running an instance of the Control Program, step 302. The server catches all incoming page requests from clients. The CP works in conjunction with the Dynamic Database Reader to retrieve content from a database and provide formatted data for rendering by a browser. When a page request is received, the CP downloads the DDR to the client browser and executes it, step 304, typically within the browser's protected memory space to avoid erroneous or malicious code from affecting unrelated processes running in memory. The DDR is instantiated with page request parameters, which are used to query the database for page content, step 306. The DDR queries the database by way of APIs provided by the CP that allows operation on the content contained within the database.

In response to the content request from the DDR, the CP reads page content from the database for the requested page, step 308, and returns each content element to the DDR as part of a formatted data stream for rendering by the browser, step 310. The DDR modifies the data stream by identifying the editable content as it is received and inserting an HTML “edit” button into the data stream as appropriate, step 312. The resultant data stream is rendered by the browser according to techniques well known in the art and presented to the user, step 314. Instead of simply seeing the page, however, the user sees each editable content element displayed on the page accompanied by an “edit” button that was placed into the data stream as it was received by the DDR.

After the data stream is rendered by the browser, the user has an opportunity to review the page and examine how each content element is formatted and configured therein. The DDR continues to execute in a background process awaiting input events from the user, step 316. If no action is taken on the part of the user, the browser continues to display the page, step 314. Otherwise, the user determines a content element that requires modification and selects the corresponding “edit” control, step 316, which issues a message to the DDR to request an appropriate In-Context Editor.

In response to the selection of the “edit” control, the DDR issues a request to the CP to dynamically generate an appropriate ICE for the selected content element, step 318. The CP determines the type of browser the user is utilizing to view the content so the appropriate call can be generated that causes the browser to instantiate a new browser window, step 320. The CP also determines the data type of the content element that is being modified and loads a data- and browser appropriate ICE into a new browser window, step 320. Once the ICE has loaded, the browser displays the ICE window, including the selected data, step 322. The ICE presents the user with an unformatted view of the selected data as it appears in the database. The ICE also contains editorial controls that allow the user to modify the currently selected content or replace it with new content from the database, commit changes to the database, or cancel editorial changes by closing the ICE window and returning to viewing solely the Web page. While the ICE is open, the user simultaneously views both the formatted Web page and selected data in the ICE window, with the ICE waiting for user input.

When the user wishes to modify the current content element, step 323, he or she simply modifies the content element directly in the ICE. For example, if textual content is displayed, it can be directly overwritten with new textual content. If an image is displayed, it can be directly overwritten with a new image through the use of GUI controls that allow the user to select a new image from a storage medium, thereby overwriting the image currently displayed in the ICE.

After the content element is modified, step 324, the ICE displays the new content value in its window, step 326. After reviewing the updated content, the user can either cancel or save the changes. If the user selects the “cancel” control, step 328, the ICE window closes without updating the database. When the ICE window closes, the user is left with a view of the formatted Web page, step 314, and is free to select additional content to edit, step 316. If the user selects neither the “cancel” control, step 328, nor the “save” control, step 330, the ICE continues to display the updated content, step 326, and await user input, steps 328 and 330. If the user is satisfied with the updated content, he or she selects the “save” control, step 330.

Continuing with FIG. 3a, upon receiving a “save” command from the user, the ICE transmits an “update” command, along with the new content value, back to the CP, step 338. Upon receipt of the “update” command, the CP updates the database to reflect the content changes, step 340. When the update is complete, the CP also issues an update confirmation to the ICE validating that the transaction was completed successfully, step 340. As soon as the ICE receives receipt of the update confirmation, it issues a page refresh command to the browser causing the current page to be reloaded from the server, step 342. By subsequently refreshing the page after updating any content elements, the user immediately sees the effect that the content substitution has on other page elements and the page as a whole. After the page refresh command is issued to the browser, the ICE dialog closes, step 344.

At this point, the in-context editing of the selected content element is complete. If the user does not close the browser window, step 346, program flow returns to step 314 with the updated page displayed in the browser window. The user is free to select additional content elements to modify. If the user has completed all necessary page updates, selecting an “exit” command from a menu provided as part of the browser user interface terminates the browser. When the browser is closed, step 346, the client side components are unloaded from memory, step 348, and processing terminates, step 350.

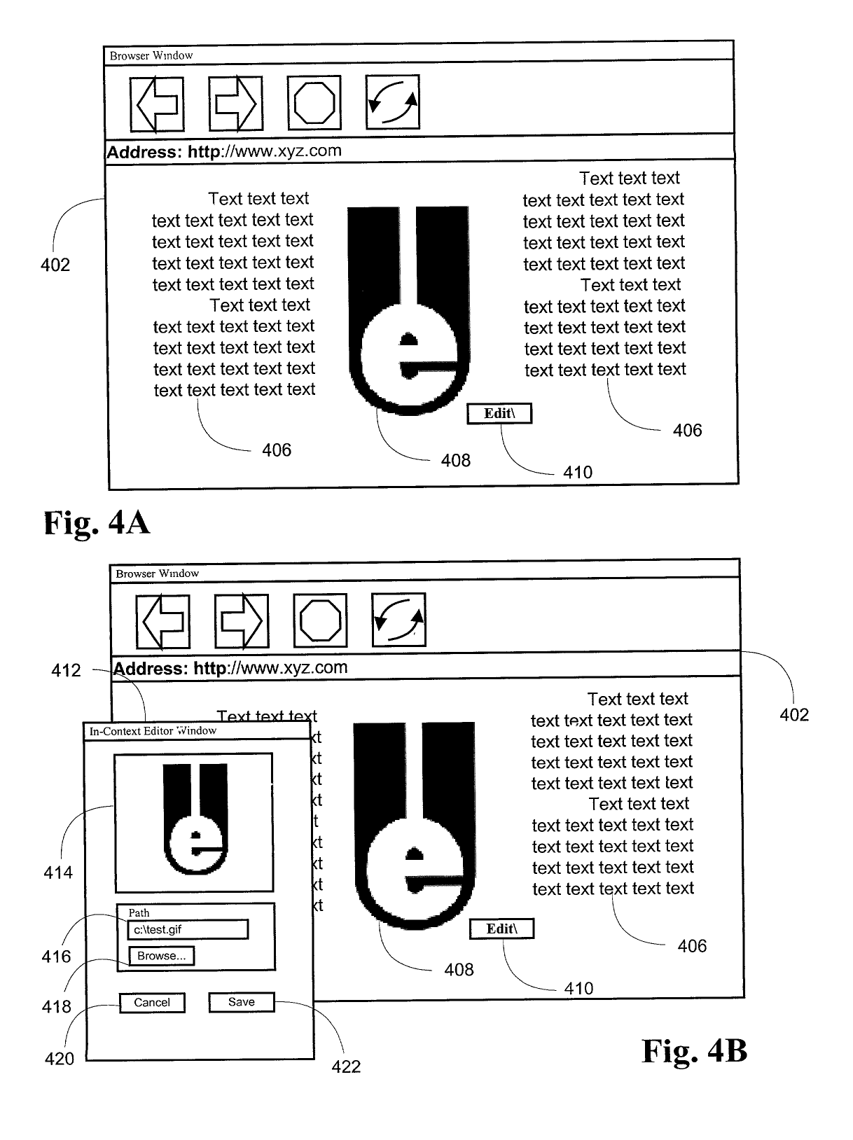

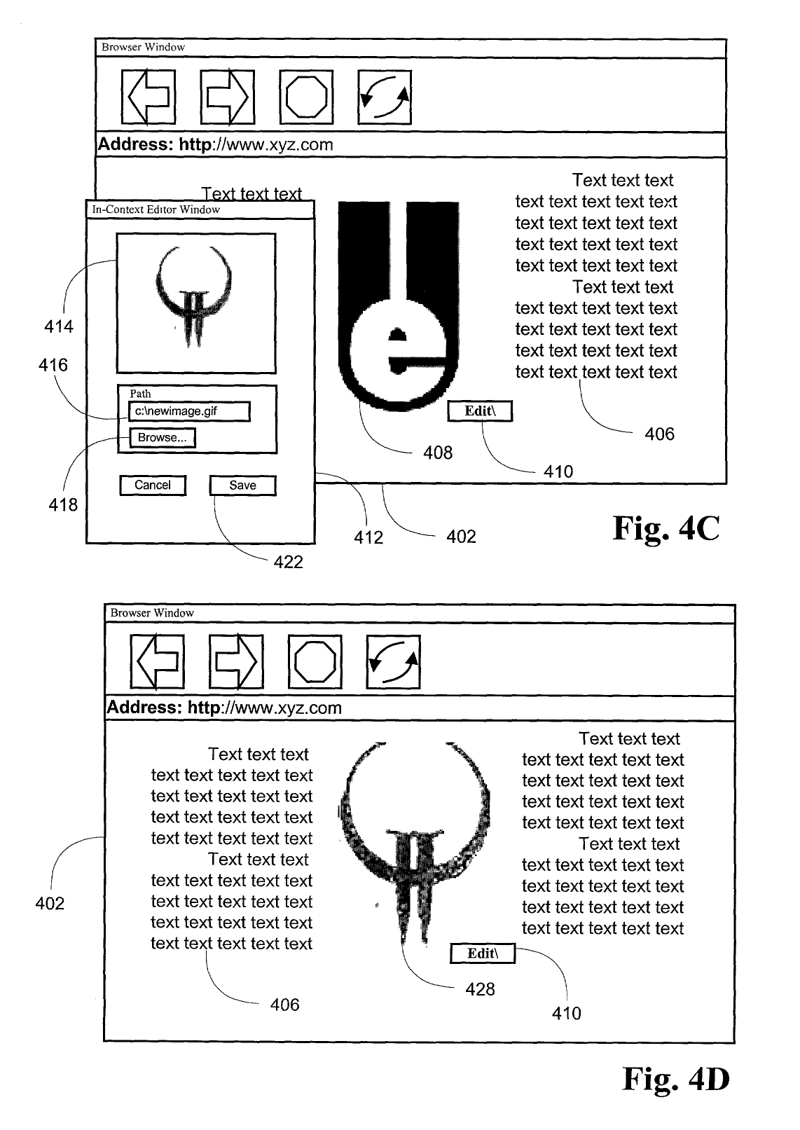

FIGS. 4A through 4D present a series of screen drawings representing an embodiment of the invention whereby editorial controls are displayed alongside formatted image data. In FIG. 4A, a browser or other content viewing application is provided 402. The browser, which is in communication with a server computer that delivers content to requesting clients, renders and presents requested content elements to a user. Content elements 406 and 408 are arranged on the page according to markup code generated by the page's author or the run time engine. An HTML “edit” button 410 is placed beside each editable content element by the DDR as the data stream containing content elements is received. Selecting the “edit” button 410 issues a message to the DDR, which is propagated across a network to the CP, that the user wishes to edit the content element associated with the selected edit control.

Turning to FIG. 4B, the CP instantiates an ICE 412 for the selected data type, where the ICE is compatible with the browser being run by the user. The ICE 412 presents the unformatted content selected by the user in a portion of its display area 414. The ICE also provides one or more controls 416 and 418 that allow the user to select a new content element to replace the one currently stored in the database for display within the browser 402. The ICE's user interface also provides controls that allow the user to rollback any changes made to the content element 420 or commit changes to the database 422, as explained by FIGS. 2 through 3A and the accompanying text.

FIG. 4C presents a new image selected by the user through the ICE interface 412. A user interacts with controls 416 and 418 that allow the user to change the content element. One option available to modify the currently selected content element is to manually supply the location of the new content element 416, for example, by entering the path to the desired content element on a storage device. Alternatively, a “browse” control 418 is provided to open a standard file navigation dialog that allows the user to navigate to and select a new content element. The new unformatted content element is displayed in the ICE window 414 for review. Upon acceptance, the newly selected content element 428 (FIG. 4D) is used to replace the current content element 408 for formatting and display with other content elements 406 within the browser 402.

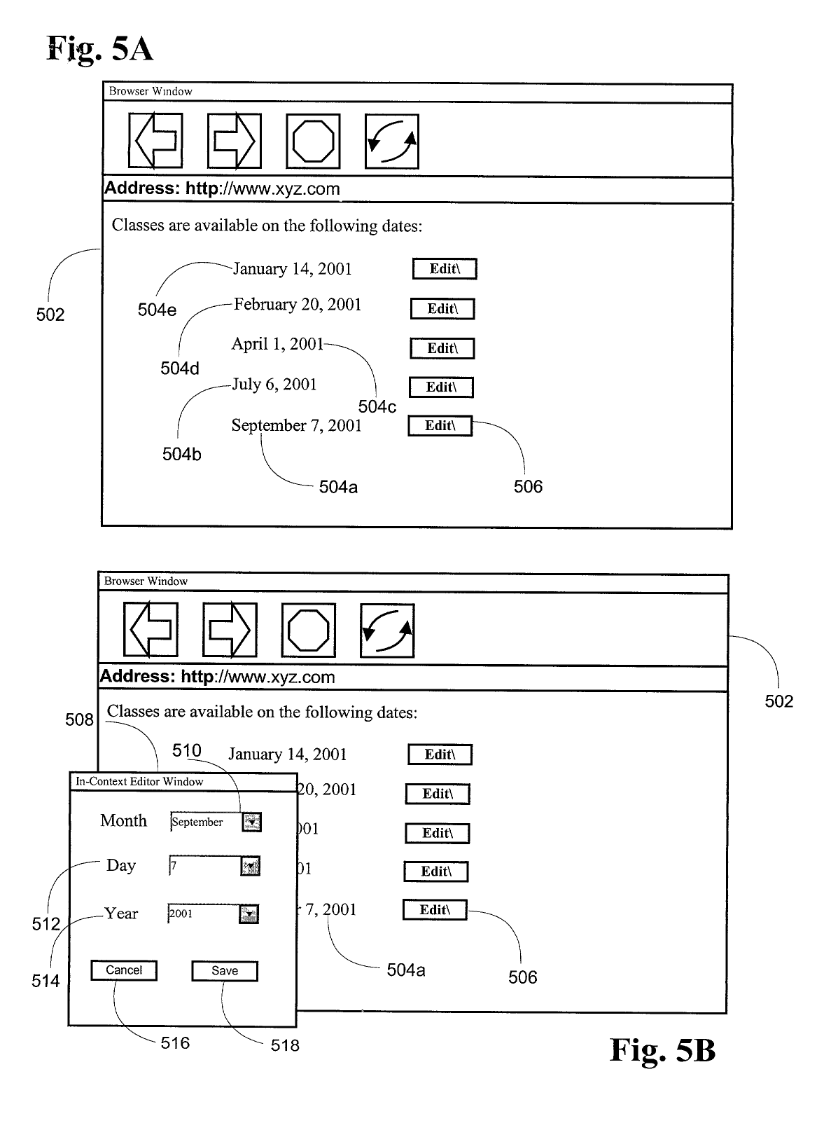

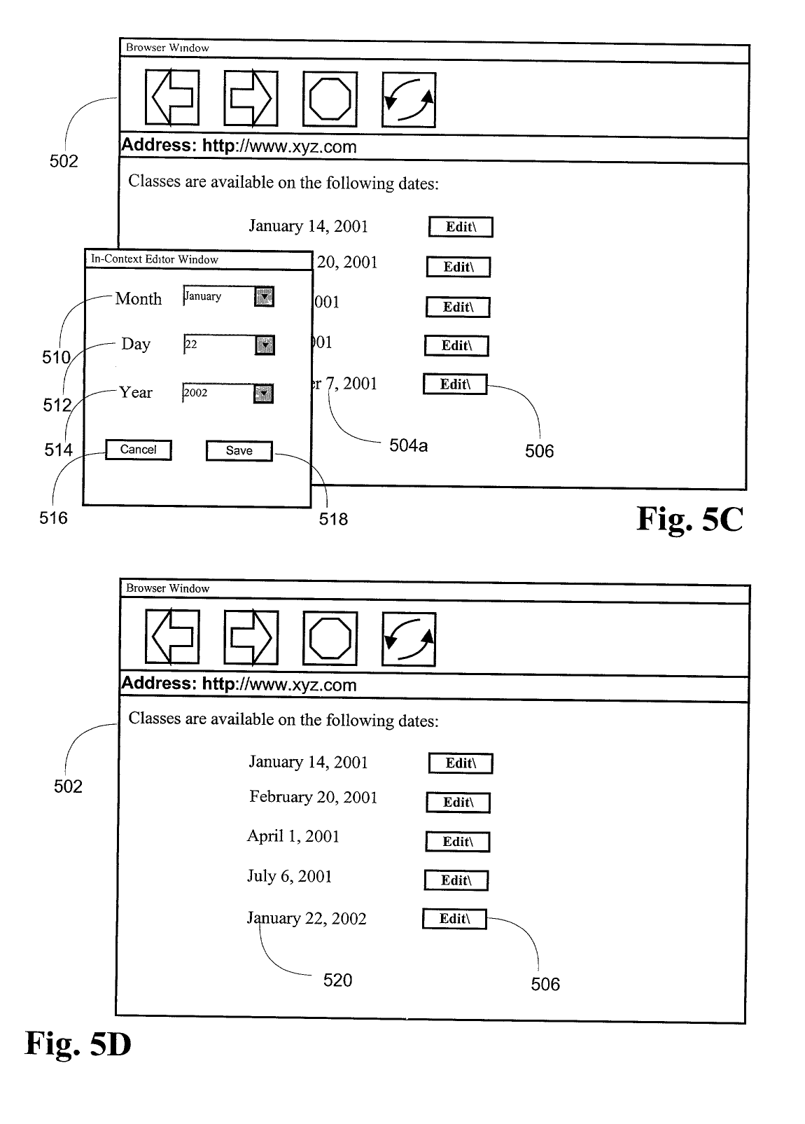

FIGS. 5A through 5D present another example of the in-context editing of content elements presented on a Web page rendered by a browser 502. A plurality of date content elements 504a, 504b, 504c, 504d, 505e, are arranged on a page according to the markup instructions contained within the page as interpreted by the browser 502. An “edit” control 506 is provided beside each editable content element. Selecting the “edit” control associated with an individual content element allows the user to modify the desired content element.

After the user selects the “edit” control associated with a desired content element, the ICE window 508 is displayed on the display device according to FIG. 5B. In this example, the user has selected content element 504a for modification. As with image data, the CP instantiates an ICE 508 for the selected data type, in this case date data, that is compatible with the browser being run by the user. The ICE 508 provides several controls 510, 512 and 514 that allow the user to select a new date for display. When instantiated, the data displayed in the date entry controls is the data for the selected content element. Alternatively, text entry controls that are well known to those skilled in the art may be provided that allows the user to manually enter the date data. Additional controls are provided to save the transaction 518 or to abort the transaction 516.

Turning to FIG. 5C, the user interacts with the data modification controls 510, 512 and 514 provided by the ICE interface. One or more of the controls 510, 512 and 514 are used to manipulate the data contained therein. When the desired data is displayed by use of the modification controls, the user selects the “save” transaction control 518, which transmits the modified data back to the CP for insertion in the database. Once the page is updated on the database, the modified page is retransmitted to the browser 502 for reformatting and presentation to the user. As presented in FIG. 5D, the refreshed page contains the modified data 520 entered by the user through the ICE interface.

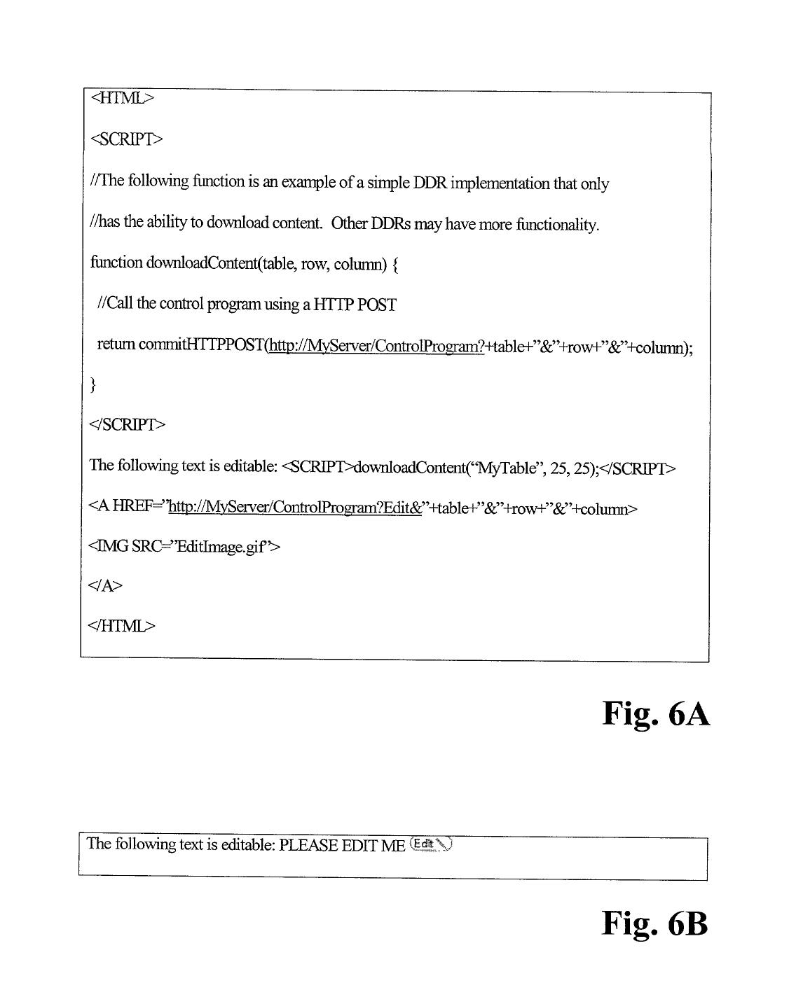

FIG. 6A presents an exemplary HTML file incorporating a DDR and used to generate output that is editable in context. The HTML file is received by the browser and rendered. The script is executed in the browser, which causes hard-coded text to be displayed on the display device. A call is also sent to the DDR to retrieve a string of text, which is also rendered and displayed on the display device. Finally, a call is sent to the control program to retrieve and display an “edit” control that allows for in-context editing of the text retrieved from the database. FIG. 6B presents the rendered HTML code presented in FIG. 6A.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A system for editing content elements, the system comprising:
a database to store the content elements;
a control program providing a set of APIs to manipulate the content elements stored in the database;
a dynamic database reader operative to obtain content from the database by means of the APIs provided by the control program and further operative to insert editorial controls associated with the content elements;
an in-context editor operative to display a selected content element and allow a user to modify the selected content element through the use of the editorial controls inserted by the dynamic database reader.

2. The system of claim 1 wherein the control program reads content elements directly from the database in response to a page request.

3. The system of claim 2, wherein the control program transmits formatted data for rendering by a browser.

4. The system of claim 1 wherein the dynamic database is operative to instantiate an in-context editor capable of displaying and modifying the selected content element.

5. The system of claim 1 wherein the control program is operative to receive a command to replace the selected content element in the database.

6. A method of editing content elements, the method comprising:
requesting a Web page, the Web page comprising the content elements stored and managed by a database;
modifying the requested Web page to associate editorial controls with content elements, the editorial controls placed in the proximity of the content elements;
selecting an editorial control to generate an in-context editor, the in-context editor operative to modify the content element associated with the selected editorial control.

7. The method of claim 6 wherein requesting a Web page is performed using a Web browser.

8. The method of claim 6 comprising downloading the in-context editor from a server.

9. The method of claim 6 wherein the step of selecting is operative to load the in-context editor in an auxiliary browser window, allowing content to be viewed on the Web page and the in-context editor.

10. The method of claim 6, the method comprising:
modifying the content element through the in-context editor;
issuing a command to the database to replace the content element with the modified content element.
issuing a refresh command to a browser to reload the Web page.
